(19) United States
(12) Patent Application Publication
(10) Pub. No.: US 2009/0038507 A1
(43) Pub. Date: Feb. 12, 2009

(54) Fluorescent-Wax Emulsion For Pigment Ink Detection

(76) Inventors: Charles Edward Akers, JR., Lexington, KY (US); Xiaorong Cai, Lexington, KY (US); Kelly Ann Killeen, Lexington, KY (US); Jun Li, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/835,682

(22) Filed: Aug. 8, 2007

(51) Int. Cl. C09D 11/02

(52) U.S. Cl. 106/31.26; 106/31.61; 106/31.85

(57) ABSTRACT

A pigment ink formulation containing a fluorescing material and a method for pigment ink detection are disclosed. Preferably, the fluorescent material is contained in a fluorescent-wax emulsion. The fluorescent-wax emulsion is added into the pigment inks. A detecting unit comprised of an UV LED and a sensor can then be used to detect the fluorescent emission from the pigment inks. The detecting unit can detect all three color inks. The differences in signal detection can be used for ink identification.

### FIELD OF THE INVENTION

The present invention relates to ink jet printers, and, more particularly, to fluorescent-wax emulsion additives for pigment ink identification.

### BACKGROUND OF THE INVENTION

In the media printing environment it is important to assure that a printing onto a media is performed accurately. For example, in an inkjet printer environment, if the inkjet printhead is out of alignment, the ink will not print on a media in the proper position. To verify the alignment of a printing apparatus, typically an alignment detector is utilized to review predetermined marks made on a media to determine whether the printing apparatus that printed such marks is in alignment.

The alignment detector typically includes at least three components, a light source, an alignment sensor, and a housing to hold both the light source and the sensor, though the housing is not necessary.

Many ink jet printers include a printhead auto-alignment detector that may be used to automatically calculate and correct for various printhead misalignments including, for example, horizontal misalignment between two printheads, vertical misalignment between two printheads, bi-directional misalignment of a printhead, and skew misalignment of a printhead. The auto-alignment detector typically includes at least three components, a light source, an alignment sensor, and a housing to one printer configuration, for example, the printer performs printhead auto-alignment using a carrier mounted printhead auto-alignment detector that moves with the printhead carrier across a printed test pattern of ink marks or blocks.

For example, one known technique to determine bi-directional misalignment is to print a plurality of rectangular blocks along the main scanning axis, i.e., the scanning axis of the printhead, with odd blocks printed from left to right and with even blocks printed from right to left with the intent of placing an even block exactly midway between two adjacent odd blocks. After printing, in one technique, the sensor is passed over the pattern to measure the distances between adjacent blocks, such as for example, by using the position encoder of the printhead carrier or by using a timer and the known speed of the sensor. Unequal distances are a measure of bi-directional misalignment which, in one technique, is corrected for by advancing or delaying the firing times when printing right to left so that, in the case of the test pattern, the blocks from bi-directional printing are printed an equal distance apart.

Ink jet printers and all-in-one (AIO) devices that include a scanner part and a printer part have increased their reliance on auto alignment, and there is a desire to place more and more information on the auto alignment page. Examples of auto alignment technology for ink jet printers and all-in-one (AIO) devices that include a scanner part and a printer part are described in U.S. Pat. No. 7,044,573, U.S. Pat. No. 6,655,777, U.S. Pat. No. 6,616,261, U.S. Pat. No. 6,485,124, U.S. Pat. No. 6,450,607, and U.S. Pat. No. 6,281,908, all of which are incorporated herein by reference.

Many current Ink jet printers and all-in-one (AIO) devices that include a scanner part and a printer part have an auto-alignment feature that uses two LED's and a sensor to align each color ink individually. The LED's are different colors because each ink has a different peak reflectance wavelength and one color of LED may “see” one ink well, but not another. For example, when the auto-alignment detector only used a red LED, the cyan nozzles could be aligned well and the magenta nozzles could be aligned with a little more optimization but the yellow nozzles could not be aligned. With a red LED, the yellow ink was not distinguishable from the white paper. A blue LED has to be added to the auto-alignment detector so that the yellow nozzles could be aligned.

What is needed in the art is a method for simplifying the auto-alignment detection by only requiring the use of a single LED and further, to improve the performance for auto-alignment and any color correction method integrated into the printer.

Pigment ink has good water fastness. Water soluble fluorescent material can be easily added into the pigment ink for detection, but the poor water fastness of water soluble fluorescent material will cause the reduction of water fastness for the pigment inks. Solvent based fluorescent materials or fluorescent pigment have good water fastness but can not be added into the pigment ink directly.

Adding wax materials into pigment will improve photo smudge, scratch and scuff resistance. By processing the wax emulsion with fluorescent dyes/pigments, extra benefits can be received. The fluorescent-wax emulsion can be added into color pigment inks for ink detection and identification. It will also improve pigment photo image handling.

This invention provides a method of pigment ink identification, printhead alignment and ink quantification by adding a fluorescent-wax emulsion into the inks.

### SUMMARY OF THE INVENTION

The present invention provides a pigment ink formulation containing a fluorescing material and a method for pigment ink identification. The fluorescing material is first added into the pigment inks. Preferably, the fluorescent material is contained in a fluorescent-wax emulsion. The fluorescent-wax emulsion is processed by dissolving or mixing the fluorescent material into wax and processed with surfactant/dispersant to form the stable emulsion. The fluorescent-wax emulsion can be added into color pigment inks for printhead alignment, pigment ink identification and/or quantification.

A detecting unit comprised of an UV LED and a sensor can then be used to detect the fluorescent emission from the pigment inks. The detecting unit can detect all three color inks and perform the alignment tasks. The differences in signal detection can also be used for pigment ink identification and quantification.

As discussed below, the present invention simplifies the auto-alignment detector by only requiring the use of a single LED and further, can improve the performance for auto-alignment and any color correction method integrated into the printer.

Many current inkjet printers have an auto-alignment feature that uses two LED's and a sensor to align each color ink individually. The LED's are different colors because each ink has a different peak reflectance wavelength and one color of LED may “see” one ink well, but not another. For example, when the auto-alignment detector only used a red LED, the cyan nozzles could be aligned well and the magenta nozzles could be aligned with a little more optimization but the yellow nozzles could not be aligned. With a red LED, the yellow ink was not distinguishable from the white paper. A blue LED has to be added to the auto-alignment detector so that the yellow nozzles could be aligned.

In the present invention, a fluorescing material is processed with wax and formed into a stable fluorescent-wax emulsion. The fluorescent-wax emulsion is added to and mixed uniformly with the inks. The fluorescing material has a narrow absorbing band and narrow emitting band such that when the light within the narrow absorbing band excites on the mixed inks, the signal within the narrow emitting band comes only or mainly from the added fluorescing material (none or very little comes from the inks themselves). For example, a fluorescing material can be used that absorbs light in the non-visible spectrum of light (below 400 nm—UV) and re-emits light in the visible or near-IR spectrum of light (about 400 nm to 1000 nm).

Because of the fluorescing material in the ink, there only needs to be one LED with a peak wavelength that is the same as or very close to the wavelength that the fluorescing material absorbs. This LED preferably has a peak wavelength in the UV region (300 nm-400 nm). Second, the sensor needs to block the 300 nm-500 nm range of wavelengths. This would block the reflected UV light from the LED and the emission from any optical brighteners in the paper. Thus the auto-alignment sensor unit can “see” all inks equally well and in some cases even better than what is possible with current systems.

In the current invention, fluorescent dye/pigment in wax emulsion allows solvent fluorescent dye or pigment to be added into the pigment ink without reducing the water fastness. The inks will be functional in ink detection and auto alignment, as well as provide better image handling.

All percentages and ratios, used herein, are “by weight” unless otherwise specified. All molecular weights, used herein, are weight average molecular weights unless otherwise specified.

Additional embodiments, objects and advantages of the present invention will be further apparent in view of the following detailed description.

### DETAILED DESCRIPTION OF THE INVENTION

The present invention provides a pigment ink formulation containing a wax fluorescing emulsion and a method for pigment ink identification. The fluorescing material is first processed with wax and formed into a stable fluorescent-wax emulsion. The fluorescent-wax emulsion is added into the pigment inks. A detecting unit comprised of an UV LED and a sensor can then be used to detect the fluorescent emission from the pigment inks. The detecting unit can detect all three color inks and perform the pigment ink identification tasks. The differences in signal detection can also be used for printhead auto-alignment as well as any color correction method integrated into the printer.

As used herein, the terms “pigment ink identification” and “pigment ink detection” mean that the inks are unique and can be distinguished from all other inks.

In a preferred embodiment the UV fluorescing material can absorb light from a UV LED in the wavelengths between 250 nm to about 400 nm and emit in the visible range between about 500 nm to about 700 nm. The UV fluorescing material can be a dye or a pigment with dyes being preferred. Preferred dye colors include red (e.g., Keyfluor Red OB615, Keystone Invisible Fluorescent Red dye supplied by Keystone Aniline) and yellow (e.g., Keyplast Yellow 10G Keystone Fluorescent Yellow dye supplied by Keystone Aniline).

Other suitable fluorescent dyes include invisible or visible dyes and pigments that absorb energy of UV and visible light with wavelength from 254 nm to 700 nm and emit light with wavelength between 400 nm and 1.2 micron. Examples include organic fluorescent dye/pigments, such as derivatives of benzoxazine and benzoxazinone or complexes of rare earth elements. Other colorants such as fluorescent derivatives of dansyl chloride, coumarin, carbocyanine, naphthalamide, stilbene, squarine, perylene, xanthene, thioxanthene, thioindigoid, acridine, and anthrapyridone dyes and pigments would also be included for this application.

Water soluble fluorescent material can be easily added into the pigment ink for detection, but the poor water fastness of water soluble fluorescent material may cause the reduction of water fastness for the pigment inks. Solvent based fluorescent materials or fluorescent pigment has good water fastness but can't be added into the pigment ink directly. Pigment inks containing wax emulsion have improved photo smudge, scratch and scuff resistance. Applicants have discovered that by modifying the wax emulsion with fluorescent dyes/pigments, extra benefits can be received. The fluorescent-wax emulsion is processed by dissolving or mixing the fluorescent material into wax and processed with surfactant or dispersant to form a stable emulsion. The fluorescent-wax emulsion can be added into color pigment inks for ink detection and identification as well as printhead auto-alignment. In other words, the pigment inks containing a fluorescent-wax emulsion not only improve photo smudge, scratch and scuff but also can be detected using a LED-sensor system built into the printer.

The fluorescent wax emulsion has three parts: the fluorescing material which is preferably an oil soluble dye as discussed above, the wax and the dispersant or surfactant. The wax can be any type of wax known to those skilled in the art. Examples of suitable types of waxes include, but are not limited to, polyethylene, polypropylene, polyester, natural waxes such as carnauba or bees wax, etc. The preferred wax type for the current invention is polyethylene. The wax must be hydrophobic to blend well with the oil soluble dye. Low levels of oxidation can be tolerated. The wax emulsion is an aqueous based solution, so waxes with melt points below 100° C. are preferred in order to avoid requiring the use of pressurized reactors to form the emulsion. Any of the polyethylene Polywaxes from Baker Petrolite can be used to blend in the oily dye in terms of hydrophobicity. PW 500 is preferred due to the fact that it has a favorable melt point.

In the current invention, any surfactant known to those skilled in the art can be used as a dispersant for the mixture of wax and fluorescing material. Anionic surfactants are preferred in the fluorescent wax emulsions of the present invention. Surfactants from the groups of alkyl ether sulfates, alkyl ether carboxylates, and alkyl sulfates are preferred in the sodium or potassium salt forms. Specifically, sodium lauryl ether sulfate, sodium lauryl sulfate, or Akypo RLM 100 sodium salt are the preferred dispersants for the current invention. In general the best surfactants have an alkyl hydrophobic tail for better interaction with the wax and carboxylic or sulfonic acid groups for long term electrostatic stabilization of the emulsion. The ethylene oxide groups of the alkyl ethers offer steric stabilization to further enhance the long term stability.

The fluorescent wax emulsions of the present invention can be made by typical homogenization methods used by those skilled in the art. Some examples are the use of an ultrasonic horn such as the Branson Sonifier 450, the use of a Microfluidizer such as the Model 110Y from Microfluidics, or the use of a rotor-stator type homogenizer such as the Ultra-Turrax T50 from IKA. Each type of equipment may require some small changes in process, but overall the formation of the emulsion follows the same principals.

The examples for this invention use ultrasonication as the method for forming the emulsions. The wax and surfactant are mixed in water first and the solution is heated above the melt point of the wax. In the case of PW 500, the solution is heated to above 90° C. When the temperature is above the melt point of the wax, the dye is added into the solution with stirring. Once all of the dye is added, the sonication is started. A Branson Sonifier 450 with a ½ inch flat tip was used and the output was adjusted to 30%. Depending on the formula used, it takes about 45 to 50 minutes to get an emulsion with a particle size under 300 nm. In the formulation, the wax:surfactant ratio can vary from 1:1 to 11:1 with fluorescent dye percentages from 5% to 10% based on the solids in the emulsion. The total solids in the emulsion ranged from 8% to 15% solids. The pH was targeted at from about 7.0 to about 8.0.

Fluorescent pigment or dye used in the invention can have invisible or visible color under visible light. Invisible fluorescent-wax emulsion can be added into all color pigment inks. Colored fluorescent-wax emulsion can be added into similar color pigment inks, for example, yellow fluorescent-wax emulsion can be added into yellow pigment ink.

There are at least two methods of adding the fluorescing material to the inks. In the first method, the same fluorescing material would be added to all of the inks: cyan, magenta, yellow, and any other photo inks used. This fluorescing material would absorb in the UV band and re-emit in the visible or near-IR range of about 500 nm-1000 nm. This would avoid the optical brighteners added to paper that have emission peaks at around 400 nm-500 nm. The emission signal of fluorescent material in the ink should be strong enough to distinguish the emission of paper brightener at other visible wavelengths.

A second method is to use a different fluorescing material for each ink. Again, all of these materials would absorb at the same wavelength in the UV band (such as 365 nm) and re-emit in the visible to near IR range of 500 nm-1000 nm, again avoiding the 400 nm-500 nm band where optical brighteners re-emit. However, the material in each ink would reflect at a wavelength that corresponds to that ink's color. For example, the material in cyan would reflect at around 500 nm, the material in magenta would reflect at around 700 nm, the material in yellow would reflect at around 600 nm.

There are other potential methods of adding fluorescing material(s) to the inks, but there are practical considerations that should dictate how this is done. Several common light sources have a UV component. This may affect the color of the printed image. Materials that re-emit in the near-IR are optimal since the re-emission spectrum will not interfere with the color. If a material is used that does re-emit in the visible, then it should re-emit at a wavelength that is compatible with the color of the ink.

The auto-alignment technology and/or color correction technology for ink jet printers and all-in-one (AIO) devices used in the invention consist of one LED with a peak wavelength that is the same as or very close to the wavelength that the fluorescing material absorbs. This LED preferably has a peak wavelength in the UV region (300 nm-400 nm). A color filter is applied to the optical sensor. The color filter blocks the reflected UV light from the LED and the reflection from printed color inks. Thus the auto-alignment detector unit and/or color correction system would “see” all inks equally well at the UV fluorescent emission wavelengths

The aqueous inkjet ink compositions of the present invention comprise color pigment and a UV fluorescing material in an aqueous medium. The aqueous medium may comprise water, preferably distilled and/or deionized water, or may comprise water in combination with one or more water-miscible organic solvents. In a preferred embodiment, the aqueous medium is deionized water.

The UV fluorescing material can be wax soluble or miscible, and is processed to a water miscible emulsion or dispersion as described above.

A wide variety of organic and inorganic pigments are known in the art for use in inkjet printing systems and are suitable for use in the compositions of the present invention, alone or in combination. The pigment dispersion particles must be sufficiently small to permit free flow of the ink through the inkjet printing device, and particularly the ink jet print nozzles, which typically have diameters in the range of from about 10 to about 50 μm, and more typically of about 30 μm or less. The particle size of the pigment should also be selected to maintain pigment dispersion stability in the ink, and it is generally desirable to use smaller sized particles for maximum color strength. Accordingly, pigment dispersion particles having a size in the range of from about 50 nm to about 5 μm, and more preferably less than about 1 μm, are preferred.

Pigments which are suitable for use in the present compositions include, but are not limited to, azo pigments such as condensed and chelate azo pigments; polycyclic pigments such as phthalocyanines, anthraquinones, quinacridones, thioindigoids, isoindolinones, and quinophthalones; nitro pigments; daylight fluorescent pigments; carbonates; chromates; titanium oxides; zinc oxides; iron oxides and carbon black. In one embodiment, the pigment is other than a white pigment, such as titanium dioxide. Preferred pigments employed in the ink composition include carbon black and pigments capable of generating a cyan, magenta and yellow ink. Suitable commercially available pigments include, for example, Pigment Red 81, Pigment Red 122, Pigment Yellow 13, Pigment Yellow 14, Pigment Yellow 17, Pigment Yellow 74, Pigment Yellow 83, Pigment Yellow 128, Pigment Yellow 138, Pigment Orange 5, Pigment Orange 30, Pigment Orange 34, Pigment Blue 15:4 and Pigment Blue 15:3. The pigments may be prepared via conventional techniques.

The ink compositions may also include a dispersant, typically for dispersing the pigment therein. The dispersant may be polymeric or nonpolymeric. The term “polymeric dispersant” as used herein, is meant to include homopolymers, copolymers, terpolymers and immiscible and miscible polymer blends. Suitable non-polymeric dispersants include naphthalene sulfonic acid, sodium lignosulfate and glycerol stearate. Numerous polymeric dispersants are known in the art and are suitable for use in the present compositions. The polymeric dispersant may comprise a random polymer or a structured polymer, for example a block copolymer and/or branched polymer, or mixtures thereof, and the dispersant polymer may be anionic, cationic or nonionic in nature. Suitably, polymers having both hydrophilic sections for aqueous compatibility and hydrophobic sections for interaction with the pigment are preferred.

Suitable polymeric dispersants are known in the art, for example, in U.S. Pat. No. 5,821,283, U.S. Pat. No. 5,221,334, U.S. Pat. No. 5,712,338, and U.S. Pat. No. 5,714,538, all of which are incorporated herein by reference. Alternatively, pigment known as a self-dispersed pigment can be used or mixtures of a self-dispersed pigment and a pigment with dispersant. Pigments known as self-dispersed pigments or self-dispersing have been created with a surface modification. Such pigments can be surface modified in a variety of ways including, but not limited to, treatment with alkali salts of hypochlorite, ozone, and diazonium salts of aromatic sulfonic acid additions. These surface modified pigments have the distinct advantage of being self-dispersed in aqueous media and can be used without a corresponding polymeric dispersing agent. The surface modification can be performed on both black and color pigments.

For the purposes of this invention, the polymeric dispersant composition is not critical as long as its use results in a stable and printable ink. Polymeric dispersants are typically used at 0.1 to 5 wt %, based on the total weight of the ink. Pigment dispersions can be made by mixing pigment, dispersant, water, and optional additives and milling in, for example, a horizontal media mill, a vertical media mill, and an attritor mill.

The aqueous ink jet compositions may also include a humectant. Humectants for use in ink jet ink compositions are known in the art and are suitable for use herein. Examples include, but are not limited to, alcohols, for example, glycols such as 2,2′-thiodiethanol, glycerol, 1,3-propanediol, 1,5-pentanediol, polyethylene glycol, ethylene glycol, diethylene glycol, propylene glycol and tetraethylene glycol; pyrrolidones such as 2-pyrrolidone; N-methyl-2-pyrrolidone; N-methyl-2-oxazolidinone; and monoalcohols such as n-propanol and iso-propanol.

Preferably the humectants are selected from the group consisting of alcohols, glycols, pyrrolidones, and mixtures thereof. Preferred humectants include 2,2′-thiodiethanol, glycerol, 1,3-propanediol, 1,5-pentanediol, polyethylene glycol, ethylene glycol, diethylene glycol, triethylene glycol, propylene glycol, tetraethylene glycol, 2-pyrrolidone, n-propanol and mixtures thereof.

The aqueous ink jet ink compositions according to the present invention may employ the pigment, humectant, and dispersant in amounts suitable for obtaining desired print properties. In preferred embodiments, the aqueous compositions comprise, by weight, from about 1% to about 20% pigment, from about 5% to about 50% humectant, and from about 0.01% to about 10% dispersant, and from about 0.01% to about 2% fluorescing material. More preferably, the compositions comprise, by weight, from about 1% to about 10% pigment, from about 10% to about 30% humectant, from about 0.1% to about 5% dispersant, and from about 0.05% to about 1% of the fluorescing material. Even more preferred, are compositions comprising, by weight, from about 4% to about 8% pigment, from about 15% to about 25% humectant, from about 0.1% to about 4% dispersant, and from about 0.1% to about 0.5% fluorescing material.

The ink compositions may further include conventional additives known in the art. For example, the compositions may comprise one or more biocides to allow long term stability. Suitable biocides include benz-isothiazolin-one, methyl-isothiazolin-one, chloro-methyl-isothiazolin-one, sodium dihydroacetate, sodium sorbate, sodium 2-pyridinethiol-1-oxide, sodium benzoate and sodium pentachlorophenol. Examples of commercially available biocides are Zolidine™, Proxel™, Givguard™, Canguard 327™ and Kathon® PFM. The compositions may further include fungicides, bactericides, penetrants, surfactants, anti-kogation agents, anti-curling agents and/or buffers, various examples of which are known in the art. The inkjet ink compositions suitably have a pH of from about 7.5 to about 8.5.

The aqueous ink jet ink compositions may be prepared in accordance with conventional processing techniques. Typically, the pigment is combined with the dispersant to provide a pigment dispersion which is then combined with additional components of the compositions. The compositions may be employed in ink jet printing methods in a conventional manner, wherein a droplet of the ink composition is ejected through a printhead nozzle in response to an electrical signal and onto a surface of a paper recording medium.

The present invention also encompasses pigment ink detection and/or printhead auto-alignment detection systems comprising the aqueous inkjet inks described above, a UV LED that transmits light in the non-visible spectrum of light from 100 nm to about 400 nm, preferably in the wavelengths between 250 nm to about 400 nm; and a sensor capable of detecting light in the wavelengths from the visible to near IR range of 500 nm-1000 nm, preferably between about 500 to about 700 nm.

The following example is a description of the aqueous pigmented inkjet ink compositions and pigment ink detection systems of the present invention. The descriptions fall within the scope of, and serve to exemplify, the more general description set forth above. The example is presented for illustrative purposes only, and is not intended as a restriction on the scope of the invention.

### EXAMPLE

The fluorescent dye in the following example is Keyfluor Red OB615 invisible fluorescent dye with excitation wavelength peak at 365 nm and emission peak at 615 nm. The fluorescent dye was processed with PW500 wax from Baker Petrolite and Akypo RLM 100 surfactant from Kao Corp. The homogenization was carried out using a Branson Sonifier 450 with the output set at 30%. First, 3.5 g of Akypo RLM 100 at 88.1% active and 135 g of DI water were added to a 250 mL beaker. The mixture was stirred with a magnetic stir bar until the Akypo completely dissolved in the water. The pH was then adjusted to 8.65 using 3.79 g of 5% sodium hydroxide. 10.84 g of PW500 was then added to the beaker. The beaker was then heated to 93° C. with stirring. At that point it was observed that the wax had completely melted. 1.08 g of the fluorescent dye was then added to the mixture with stirring while maintaining the temperature at around 93° C. After all of the dye was wetted the ultrasonication was started. Samples were tested during sonication to determine an endpoint based on particle size. A Nanotrac particle size analyzer was used to measure particle size. After 45 minutes of sonication the particle size reached 240 nm and sonication was stopped. The % solids was measured and determined to be 14.56%. 46.7 g of DI water was added to adjust the solids to 9.9% . This solution was then used to add to ink formulations.

Printhead #1
Lexmark Pigment cyan
Lexmark pigment magenta ink
Lexmark pigment yellow ink

Printhead #2
Lexmark pigment cyan ink containing:
2% fluorescent-wax emulsion
(0.2% Keyfluor Red OB-615, from Keystone Aniline)
Lexmark pigment magenta ink containing:
1% fluorescent-wax emulsion
(0.1% Keyfluor Red OB-615, from Keystone Aniline)
Lexmark pigment yellow ink containing:
2% fluorescent-wax emulsion
(0.2% Keyfluor Red OB-615, from Keystone Aniline)

Printhead #3
Lexmark pigment cyan ink containing:
1% fluorescent-wax emulsion
(0.1% Keyfluor Red OB-615, from Keystone Aniline)
Lexmark pigment magenta ink containing:
1% fluorescent-wax emulsion
(0.1% Keyfluor Red OB-615, from Keystone Aniline)
Lexmark pigment yellow ink containing:
1% fluorescent-wax emulsion
(0.1% Keyfluor Red OB-615, from Keystone Aniline)

Printhead #4
Lexmark pigment cyan ink containing:
0.5% fluorescent-wax emulsion
(0.05% Keyfluor Red OB-615, from Keystone Aniline)
Lexmark pigment magenta ink containing:
0.5% fluorescent-wax emulsion
(0.05% Keyfluor Red OB-615, from Keystone Aniline)
Lexmark pigment yellow ink containing:
0.5% fluorescent-wax emulsion
(0.05% Keyfluor Red OB-615, from Keystone Aniline)

Three color blocks, cyan, magenta and yellow, were printed with the above four sets of inks using linear color table and Dell Photo 966 printer. The printed samples were measured using a portable detecting unit. The detecting unit consists of a 365 nm UV LED, a light filter to purify the LED wavelength, a clear sensor with a red filter, and a multi-meter to measure the voltage that converts the signal from the emission.

When LED light source hit the pigment ink printed samples, the small amounts of fluorescent material in the ink absorbed the energy from the particular wavelength light of the UV LED. The dye molecules turned into a transition state (excited state) and then, released the energy by emitting the particular wavelength light and went back to the stable state (ground state). The sensor detected a higher signal in that particular wavelength of light which included reflective light from printed pigment inks and emitted light from fluorescent materials. The signal was transferred into the electric voltage. The voltage measurements from the printed samples containing fluorescent materials are higher than that from the samples without fluorescent materials. The voltage difference provided the information for identifying the ink. The information could also be used for printhead alignment and ink quantification.

TABLE I
Fluorescent signal evaluation - Keystone invisible red fluorescent dye

| | | Detected | | |
|---|---|---|---|---|
| | | signal level | | |
| Print- | | (mv) | | |
| head | Ink | Cyan | Magenta | Yellow |
| 1 | Lexmark Standard Pigment ink w/o | 34 | 117 | 36 |
| | fluorescent-wax emulsion | | | |
| 2 | Std. pigment ink + 0.2% Keystone | 54 | na | 59 |
| | Invisible Red (2% fluo-wax | | | |
| | emulsion) | | | |
| 3 | Std. pigment ink + 0.1% Keystone | 43 | 137 | 40 |
| | Invisible Red (1% fluo-wax | | | |
| | emulsion) | | | |
| 4 | Std. pigment ink + 0.05% Keystone | 40 | 137 | 38 |
| | Invisible Red (0.5% fluo-wax | | | |
| | emulsion) | | | |

Higher voltage readings in the above table reflected the existence of fluorescent materials in the pigment inks. Higher amount of fluorescent material in the inks gave higher voltage readings. Images printed with ink set #2 and #3 showed strong fluorescence under 365 nm black light. Printed samples on micro-porous paper also showed excellent smear, smudge, scratch and scuff resistance because of the addition of fluorescent-wax emulsion in the pigment inks.

Several dye and pigment inks from other companies were compared with ink set #2. The highest voltage readings from the inks with fluorescent-wax additives provided enough information for ink detection and identification. (Table II. Dell Photo 966 printer with default color table):

TABLE II

| | | Detected | | |
|---|---|---|---|---|
| | | signal level (mv) | | |
| Printhead | Ink | Yellow | Green | Red |
| 1 | Lexmark Standard Pigment ink | 49 | 38 | 40 |
| | w/o fluorescent-wax emulsion | | | |
| | Lexmark dye inks | 36 | 32 | 36 |
| | HP38 Pigment inks | 49 | 38 | 39 |
| | HP97 Dye inks | 49 | 30 | 37 |
| 2 | Std. pigment ink + 0.2% Keystone | 86 | 56 | 53 |
| | Invisible Red (2% fluo-wax | | | |
| | emulsion | | | |

While this invention has been described with respect to embodiments of the invention, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An aqueous inkjet ink for inkjet printers comprising a color pigment, a UV fluorescing material, and an aqueous carrier.

2. The aqueous inkjet ink of claim 1 wherein the fluorescing material comprises from about 0.01% to about 2.0% of the aqueous inkjet ink.

3. The aqueous inkjet ink of claim 2 wherein said UV fluorescing material is a dye or pigment.

4. The aqueous inkjet ink of claim 3 wherein said UV fluorescing material is a dye.

5. The aqueous inkjet ink of claim 4 wherein said dye comprises from about 0.05% to about 1.0% of the aqueous inkjet ink.

6. The aqueous inkjet ink of claim 2 wherein said UV fluorescing material can absorb light from a UV LED in the wavelengths between 250 nm to about 400 nm and emit in the visible range between about 500 nm to about 700 nm.

7. The aqueous inkjet ink of claim 3 wherein said UV fluorescing material can absorb light from a UV LED in the wavelengths between about 250 nm to about 400 nm and emit in the visible range between about 500 nm to about 700 nm.

8. The aqueous inkjet ink of claim 1 wherein said UV fluorescing material is added to the ink in the form of a wax emulsion.

9. The aqueous inkjet ink of claim 8 wherein said wax emulsion comprises the UV fluorescing material, a wax, and a surfactant or dispersant.

10. The aqueous inkjet ink of claim 9 wherein said wax emulsion is formed by dissolving or dispersing the fluorescent material into the wax, followed by emulsification of the wax-fluorescent solution or dispersion in a water solution comprising the surfactant or the dispersant.

11. The aqueous inkjet ink of claim 9 wherein the fluorescing material comprises from about 0.01% to about 2.0% of the aqueous inkjet ink.

12. The aqueous inkjet ink of claim 11 wherein said UV fluorescing material can absorb light from a UV LED in the wavelengths between 250 nm to about 400 nm and emit in the visible range between about 500 nm to about 700 nm.

13. The aqueous inkjet ink of claim 12 wherein said UV fluorescing material is a dye or pigment.

14. The aqueous inkjet ink of claim 13 wherein said UV fluorescing material is a dye.
